(19) United States
(12) Patent Application Publication
(10) Pub. No.: US 2007/0170147 A1
(43) Pub. Date: Jul. 26, 2007

(54) ETCHING METHOD AND METHOD OF FABRICATING OPENING

(76) Inventors: Yi-Hsiung Lin, Taipei County (TW); Chuan-Hsien Hsieh, Taipei County (TW); Chien-Jung Chen, Hsinchu City (TW); Chao-Shun Chiu, Yunlin County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/307,162

(22) Filed: Jan. 26, 2006

(51) Int. Cl. C23F 1/00; B44C 1/22; C03C 25/68; H01B 13/00

(52) U.S. Cl. 216/58; 216/41; 216/17

(57) ABSTRACT

An etching method is disclosed. First, a patterned photoresist layer is formed on a silicon material. Next, in an etching machine, using the patterned photoresist layer as a mask and using bromine hydride (HBr) as reactive gas, an etching process is performed on the silicon material. Afterwards, a ramp-down mode is used to turn off the RF power supply of the etching machine, a purge gas is injected into the etching machine for purging, and in the meantime, the gas is pumped out from the etching machine.

### BACKGROUND OF THE INVENTION

1. Field of Invention

The present invention relates to an etching method, and particularly to an etching method of silicon material.

2. Description of the Related Art

In the semiconductor etching process, the reactive ion etching (RIE) is a broadly used etching method, which combines the physical and chemical mechanisms of removing films. By using the RIE, the reactive gas in a reaction chamber is ionized for producing plasma; the reactive ions are sped up towards a wafer, and then, by means of a chemical reaction between the ions and the material to be etched on the wafer surface, an etching reaction is derived. In this way, the material can be selectively removed and various etching patterns on the wafer are formed.

In the prior art, a process for etching silicon material is usually carried out with the bromine hydride (HBr) as a reaction gas in an etching machine and the RIE is conducted. However, after turning off the radio frequency power supply (RF power supply) of the etching machine when the process of etching silicon material is completed, the bromine hydride (HBr) and the side products thereof would adhere to and condense on the wafer surface. The adherent and condensed bromine hydride (HBr), including the side products thereof, would react with vapor and form particle-like defects on the wafer surface. As a result, this leads to defects on the wafer surface in the subsequent processes and consequently affects the product yield.

### SUMMARY OF THE INVENTION

Accordingly, an object of the present invention is to provide an etching method for preventing forming particles on the wafer.

Another object of the present invention is to provide a method of fabricating openings for avoiding defects produced on the wafer.

The present invention provides an etching method as follows. First, a patterned photoresist layer is formed on a silicon material. Next, in an etching machine, using the patterned photoresist layer as a mask and using bromine hydride (HBr) as reactive gas, an etching process is performed on the silicon material. Afterwards, the radio frequency power supply (RF power supply) of the etching machine is turned off in a ramp-down mode, purge gas is injected into the etching machine for purging, and pumping the gas out of the etching machine at the meanwhile. Further, the patterned photoresist layer is removed.

According to an embodiment of the present invention, in the above-described etching method, the purge gas is, for example, inert gas, nitrogen gas, oxygen gas or a combination of any two from inert gas, nitrogen gas and oxygen gas.

According to an embodiment of the present invention, in the above-described etching method, the silicon material is, for example, a silicon substrate or a silicon material layer.

According to an embodiment of the present invention, in the above-described etching method, the material of the silicon material is, for example, monocrystalline-silicon, epitaxy silicon, polysilicon or amorphous silicon (a-Si).

According to an embodiment of the present invention, in the above-described etching method, the ramp-down mode is that the RF power supply is turned off by gradually reducing the power thereof in a specified time from a given power to zero power (0 Watt).

According to an embodiment of the present invention, in the above-described etching method, the specified time is within five seconds.

According to an embodiment of the present invention, in the above-described etching method, the given power of the RF power supply is a preset power for performing the etching process on the silicon material.

The present invention provides a method of fabricating an opening. First, a substrate is provided, wherein a dielectric layer and a patterned silicon material layer have been formed sequentially on the substrate; in the dielectric layer, a first opening defined by the patterned silicon material layer has been formed; the first opening has been filled with a photoresist material layer. Next, a patterned photoresist layer is formed on the patterned silicon material layer. The patterned photoresist layer has a photoresist opening which resides over a part of the patterned silicon material layer and the first opening. Afterwards, using the patterned photoresist layer as a mask and using bromine hydride (HBr) as reactive gas, a first etching process is performed on the patterned silicon material layer for exposing a part of the dielectric layer. Further, with an etching machine, an oxygen plasma processing is performed on the photoresist material layer to remove the partial photoresist material layer from the first opening. Furthermore, the RF power supply of the etching machine is turned off in a ramp-down mode, purge gas is injected into the etching machine for purging, and pumping the gas out of the etching machine simultaneously. In succession, using the patterned photoresist layer and the etched patterned silicon material layer as masks, a second etching process is performed on the exposed dielectric layer. Finally, the patterned photoresist layer and the photoresist material layer are removed.

According to an embodiment of the present invention, in the above-described method of fabricating an opening, the purge gas is, for example, inert gas, nitrogen gas, oxygen gas or a combination of any two from inert gas, nitrogen gas and oxygen gas.

According to an embodiment of the present invention, in the above-described method of fabricating an opening, the material of the patterned silicon material layer is, for example, polysilicon.

According to an embodiment of the present invention, in the above-described method of fabricating an opening, the ramp-down mode is that the RF power supply is turned off by gradually reducing the power thereof in a specified time from a given power to zero power (0 Watt).

According to an embodiment of the present invention, in the above-described method of fabricating an opening, the specified time is within five seconds.

According to an embodiment of the present invention, in the above-described method of fabricating an opening, the given power of the RF power supply is a preset power for performing the oxygen plasma processing on the photoresist material layer.

According to an embodiment of the present invention, in the above-described method of fabricating an opening, the material of the dielectric layer is, for example, silicon oxide.

According to an embodiment of the present invention, in the above-described method of fabricating an opening, prior to forming the patterned photoresist layer, the method further includes forming an antireflection layer on the substrate, and the antireflection layer covers the patterned silicon material layer and the photoresist material layer.

According to an embodiment of the present invention, in the above-described method of fabricating an opening, the substrate is, for example, a silicon substrate.

According to the etching method and the method of fabricating an opening of the present invention, the RF power supply of the etching machine is turned off in a ramp-down mode, purging the etching machine by using the purge gas injected into the machine and pumping the gas out of the etching machine simultaneously. Therefore, the bromine hydride (HBr) and the etching side products adherent to and condensed on the wafer surface or the particle-like defects formed by the bromine hydride (HBr), the side products and the vapor are effectively prevented or largely reduced. Further, the possibility of forming defects on the wafer surface in the subsequent processes is eliminated so that the product yield can be improved. In addition, in the method of fabricating an opening of the present invention, the electrical defect caused by the residual fencing-like dielectric layer surrounding the opening can be avoided.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a schematic cross-sectional drawing of an opening in an embodiment of the present invention.

FIGS. 2A˜2C are schematic cross-sectional drawings of an opening in another embodiment of the present invention.

### DESCRIPTION OF THE EMBODIMENTS

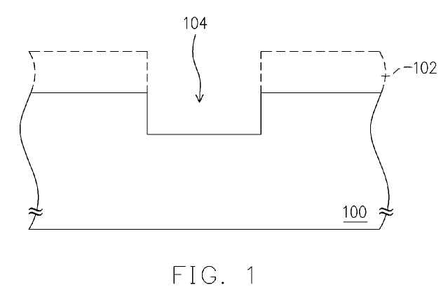

FIG. 1 is a schematic cross-sectional drawing of an opening in an embodiment of the present invention.

First, referring to FIG. 1, a patterned photoresist layer 102 is formed on a silicon material 100. The silicon material 100 can be a silicon substrate or a silicon material layer. The material of the silicon material 100 is, for example, monocrystalline-silicon, epitaxy silicon, polysilicon or amorphous silicon (a-Si). In the present embodiment, the silicon material 100 is a monocrystalline-silicon substrate as exemplary only.

Next, in an etching machine (not shown), using a patterned photoresist layer 102 as a mask and using bromine hydride (HBr) as reactive gas, an etching process is performed on the silicon material 100 to form an opening 104 in the silicon material 100. The performed etching process is, for example, a dry etching process.

Afterwards, the RF power supply of the etching machine is turned off in a ramp-down mode, purge gas is injected into the etching machine for purging, and pumping the gas out of the etching machine simultaneously. The injected purge gas is, for example, inert gas, oxygen gas or a combination of any two from inert gas, oxygen gas and nitrogen gas. The ramp-down turning off mode used by the above-described RF power supply means that the RF power supply is not directly turned off; instead, it is turned off by gradually reducing the power thereof in a specified time from a given power to zero power (0 Watt). For example, it is a ramp-down turning off mode, where the etching machine uses an RF power supply of 300 W and the RF power supply is slowly and gradually turned off from 300 W to 0 W in five seconds.

Further, the patterned photoresist layer 102 is removed.

Since the RF power supply of the etching machine is turned off in a ramp-down mode after an etching process is performed on the silicon material 100, the purge gas is injected into the machine for purging and the gas in the etching machine is simultaneously pumped out, therefore, the phenomena that bromine hydride (HBr) and the etching side products are adherent to and condensed on the wafer surface to form particles on the wafer surface is effectively prevented. The product yield is accordingly advanced.

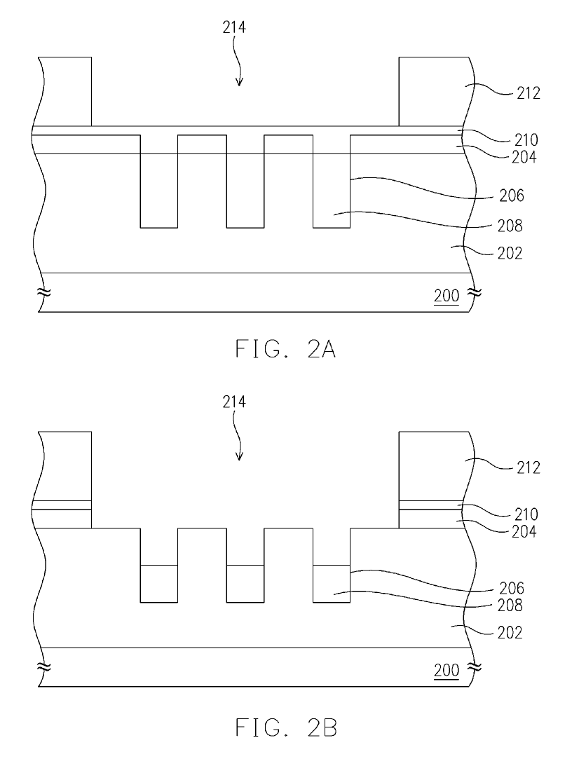

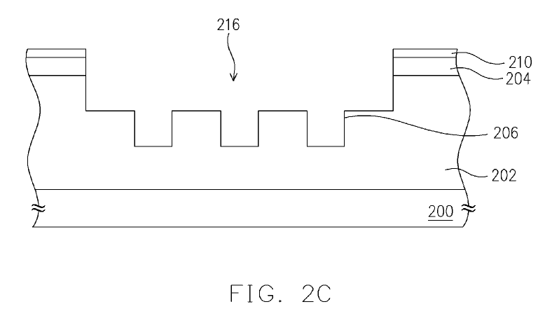

FIGS. 2A˜2C are schematic cross-sectional drawings of an opening in another embodiment of the present invention.

First, referring to FIG. 2A, a substrate 200 is provided and the substrate 200 is, for example, a silicon substrate. On the substrate 200, a dielectric layer 202 and a patterned silicon material layer 204 have been formed sequentially. In the dielectric layer 202, an opening 206 defined by the patterned silicon material layer 204 has been formed and the opening 206 has been filled with a photoresist material layer 208. The material of the dielectric layer 202 is, for example, silicon oxide, while the material of the patterned silicon material layer 204 is, for example, polysilicon. The opening 206 is, for example, a via hole. The method of fabricating the opening 206 is, for example, using the patterned silicon material layer 204 as a mask and an etching process is performed on the dielectric layer 202. Other methods for forming the dielectric layer 202, the patterned silicon material layer 204 and the photoresist material layer 208 should be well known by those skilled in the art, hence, the description is omitted.

In addition, an antireflection layer 210 can be optionally formed on the substrate 200 and the antireflection layer 210 covers the patterned silicon material layer 204 and the photoresist material layer 208.

Further, a patterned photoresist layer 212 with a photoresist opening 214 is formed on the antireflection layer 210. The photoresist opening 214 resides over the patterned silicon material layer 204 and the opening 206.

Furthermore, referring to FIG. 2B, using the patterned photoresist layer 212 as a mask, the partial antireflection layer 210 is removed. The method for removing the antireflection layer 210 is, for example, a dry etching process.

Moreover, taking the patterned photoresist layer 212 and the etched antireflection layer 210 as masks and using bromine hydride (HBr) as reactive gas, an etching process is performed on the patterned silicon material layer 204 to expose a part of the dielectric layer 202. The performed etching process is, for example, a dry etching process.

Subsequently, in an etching machine (not shown), an oxygen plasma processing is performed on the photoresist material layer 208 to remove a part of the photoresist material layer 208 in the opening 206 so as to avoid the electrical defect phenomena. Usually, if the photoresist material layer 208 in the opening 206 is not removed, in the subsequent etching process on the dielectric layer 202, due to a slower etching rate during etching the contact part between the photoresist material layer 208 and the dielectric layer 202, a fencing-like dielectric layer 202 would be resided on the surrounding of the opening 206 that leads to electrical defect phenomena.

Then, the RF power supply of the etching machine is turned off in a ramp-down mode, the purge gas is injected into the machine for purging and the gas in the etching machine is pumped out at the same time. The injected purge gas is, for example, inert gas, oxygen gas or a combination of any two from inert gas and oxygen gas. The ramp-down turning off mode is that, for example, the etching machine uses an RF power supply of 300 W and the RF power supply is slowly and gradually turned off from 300 W to 0 W in five seconds.

In succession, referring to FIG. 2C, using the patterned photoresist layer 212, the remained etched antireflection layer 210 and the remained etched patterned silicon material layer 204 as masks, an etching process is performed on the exposed dielectric layer 202 to form an opening 216. The performed etching process is, for example, a dry etching process. The opening 216 is, for example, a trench, and the opening 216 and the opening formed by the opening 206 can be applied to, for example, a process for fabricating double metal conductive traces.

Finally, the patterned photoresist layer 212 and the photoresist material layer 208 are removed.

Since the RF power supply of the etching machine is turned off in a ramp-down mode after an oxygen plasma process is performed on the photoresist material layer 208, the purge gas is injected into the machine for purging and the gas in the etching machine is simultaneously pumped out. Therefore, the particles formed by bromine hydride (HBr) adherent to and condensed on the wafer surface are reduced and the defects of the wafer surface are accordingly decreased.

In the following, the results obtained from experiments are given to prove that the present invention is able to reduce the particles on the wafer surface formed by bromine hydride (HBr).

In Table 1, the particle numbers on a wafer surface corresponding to a comparison 1, experiment 1, experiment 2 and experiment 3 are listed, respectively.

TABLE 1
Results of the Particle Numbers on a Wafer Surface Between the
Comparison 1 and the Experiments 1˜3

| | | Purging time | |
|---|---|---|---|
| Set kind | Purge gas | (s) | Particle number |
| Comparison 1 | — | — | 3494 |
| Experiment 1 | argon gas (Ar) | 30 | 123 |
| Experiment 2 | argon gas (Ar) | 15 | 163 |
| Experiment 3 | helium gas (He) | 15 | 126 |
| | and oxygen gas | | |
| | (O₂) | | |

According to the experimentation, a substrate is provided first. A dielectric layer and a patterned silicon material layer have been formed sequentially on the substrate. An opening defined by the patterned silicon material layer has been formed in the dielectric layer; the opening has been filled with a photoresist material layer. Next, on the patterned silicon material layer, a patterned photoresist layer is formed. The patterned photoresist layer has a photoresist opening, which resides over a part of the patterned silicon material layer and the opening. Afterwards, using the patterned photoresist layer as a mask and using bromine hydride (HBr) as reactive gas, an etching process is performed on the patterned silicon material layer for exposing a part of the dielectric layer. Further, with an etching machine, the RF power supply thereof is set at 300 W and an oxygen plasma processing is performed on the photoresist material layer to remove the partial photoresist material layer from the opening.

Referring to Table 1, in the comparison 1, the RF power supply is turned off immediately after performing an oxygen plasma process, and the number of the particles on the wafer is 3494.

The first experiment is the case where the RF power supply of the etching machine is turned off in a ramp-down mode after performing an oxygen plasma processing, gradually from 300 W thereof to 0 W in five seconds; argon gas (Ar) is injected into the machine to purge for 30 seconds; and during the purging, the gas in the etching machine is being pumped out. From Table 1, it is clear that the defects on the wafer surface are significantly reduced and only 123 particles are present. In comparison with the comparison 1, the improvement rate of the first experiment reaches 96.48%.

The second experiment is the case where the RF power supply of the etching machine is turned off in a ramp-down mode after performing an oxygen plasma process, gradually from 300 W thereof to 0 W in five seconds; argon gas (Ar) is injected into the machine to purge for 15 seconds; and during the purging, the gas in the etching machine is being pumped out. From Table 1, it is clear that the defects on the wafer surface are significantly reduced and only 163 particles are present. In comparison with the comparison 1, the improvement rate of the second experiment reaches 95.33%.

The third experiment is the case where the RF power supply of the etching machine is turned off in a ramp-down mode after performing an oxygen plasma processing, gradually from 300 W thereof to 0 W in five seconds; helium gas (He) and oxygen gas (O₂) are injected into the machine to purge for 15 seconds; and during the purging, the gas in the etching machine is being pumped out. From Table 1, it is clear that the defects on the wafer surface are significantly reduced and only 126 particles are present. In comparison with the comparison 1, the improvement rate of the third experiment reaches 96.39%.

In summary, the present invention has at least the following advantages:

1. The etching method of the present invention is able to prevent the phenomena that bromine hydride (HBr) and the etching side products are adherent to and condensed on the wafer surface and form particles on the wafer surface, thus the product yield is accordingly advanced.

2. The method of fabricating an opening of the present invention is able to reduce the particles formed by bromine hydride (HBr) adherent to and condensed on the wafer surface and to prevent generating defects on the wafer surface.

3. In the method of fabricating an opening of the present invention, the electrical defect phenomena caused by a residual paling-like dielectric layer surrounding the opening can be avoided.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. An etching method, comprising:
forming a patterned photoresist layer on a silicon material;
performing an etching process on the silicon material in an etching machine, wherein the patterned photoresist layer is used as a mask and bromine hydride (HBr) is used as reactive gas;
turning off the radio frequency power (RF power) of the etching machine in a ramp-down mode, injecting a purge gas into the etching machine for purging, and in the meantime, pumping out gas from the etching machine; and
removing the patterned photoresist layer.

2. The etching method as recited in claim 1, wherein the purge gas is inert gas, nitrogen gas, oxygen gas or a combination of inert gas, nitrogen gas and oxygen gas.

3. The etching method as recited in claim 1, wherein the silicon material is a silicon substrate or a silicon material layer.

4. The etching method as recited in claim 1, wherein the material of the silicon material is monocrystalline-silicon, epitaxy silicon, polysilicon or amorphous silicon (a-Si).

5. The etching method as recited in claim 1, wherein the ramp-down mode is that the RF power supply is turned off by gradually reducing the power thereof in a specified time from a given power of the RF power supply to zero power (0 W).

6. The etching method as recited in claim 5, wherein the specified time is within five seconds.

7. The etching method as recited in claim 5, wherein the given power of the RF power supply is a preset power for performing the etching process on the silicon material.

8. A method of fabricating an opening, comprising:
providing a substrate, wherein a dielectric layer and a patterned silicon material layer have been formed sequentially on the substrate, in the dielectric layer; a first opening defined by the patterned silicon material layer has been formed and the first opening has been filled with a photoresist material layer;
forming a patterned photoresist layer on the patterned silicon material layer, wherein the patterned silicon material layer has a photoresist opening and the photoresist opening resides over the partial patterned silicon material layer and the first opening;
performing a first etching process on the patterned silicon material layer to expose a part of the dielectric layer, wherein the patterned photoresist layer is used as a mask and bromine hydride (HBr) is used as reactive gas;
with an etching machine, performing an oxygen plasma processing on the photoresist material layer to remove the partial photoresist material layer in the first opening;
turning off the radio frequency power supply (RF power supply) of the etching machine in a ramp-down mode, injecting a purge gas into the etching machine for purging, and in the meantime, pumping out gas from the etching machine;
performing a second etching process on the exposed dielectric layer, wherein the patterned photoresist layer and the patterned silicon material layer after etched are used as masks; and
removing the patterned photoresist layer and the photoresist material layer.

9. The method of fabricating an opening as recited in claim 8, wherein the purge gas is inert gas, nitrogen gas, oxygen gas or a combination of inert gas, nitrogen gas and oxygen gas.

10. The method of fabricating an opening as recited in claim 8, wherein the material of the patterned silicon material layer comprises polysilicon.

11. The method of fabricating an opening as recited in claim 8, wherein the ramp-down mode is that the RF power supply is turned off by gradually reducing the power thereof in a specified time from a given power of the RF power supply to zero power (0 W).

12. The method of fabricating an opening as recited in claim 11, wherein the specified time is within five seconds.

13. The method of fabricating an opening as recited in claim 11, wherein the given power of the RF power supply is a preset power for performing the oxygen plasma processing on the photoresist material layer.

14. The method of fabricating an opening as recited in claim 8, wherein the material of the dielectric layer comprises silicon oxide.

15. The method of fabricating an opening as recited in claim 8, wherein prior to forming the patterned photoresist layer, the method further comprises forming an antireflection layer on the substrate, and the antireflection layer covers the patterned silicon material layer and the photoresist material layer.

16. The method of fabricating an opening as recited in claim 8, wherein the substrate comprises a silicon substrate.
